(19) United States
(12) Patent Application Publication
(10) Pub. No.: US 2009/0108162 A1
(43) Pub. Date: Apr. 30, 2009

(54) COMPUTER CASE MOUNTING APPARATUS

(76) Inventor: James Hatton, St. Leonards-on-sea (GB)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/102,136

(22) Filed: Apr. 14, 2008

(30) Foreign Application Priority Data
Jul. 27, 2007 (EP) EP07113358.1

(51) Int. Cl. A47B 96/06; G06F 1/00

(52) U.S. Cl. 248/311.2; 726/35

(57) ABSTRACT

A CPU holder 10 comprising a top member 12, a height adjustable side member 14, a support member 16 and retaining arms 36, and a movably mounted side arm 18. The height of the side member 14 and the length of the retaining arms 36 may be adjusted to accommodate computer cases of differing height and depth. The height and length can only be adjusted when no computer case is present. The position of the side arm 18 on the top member 12 can be adjusted according to the width of the computer case. The side arm 18 is locked in position on the top member 12 via a key operated locking arm 50 and a lock box 48. The CPU holder 10 is thereby fully size adjustable, but the height and length adjustment is secure and tamper proof when a computer case is present, so only a single external lock is required.

### TECHNICAL FIELD AND BACKGROUND OF THE INVENTION

The invention relates to computer case mounting apparatus. It is often desirable to mount a computer case (also known as a computer tower, chassis or cabinet) off the floor, to protect the case, and thus the computer hardware within it, from accidental damage, or to free up floor space. Various mounting arrangements for computer cases are known, and are often referred to as CPU holders within the industry. Generally CPU holders consist of a support frame for holding a computer case and a mounting bracket or fixing for attaching the support frame to the underside of a desktop or to a wall.

The prevention of theft of computer hardware is increasingly seen as important and many computer cases are provided with a security ring by which the computer case may be secured to a desk or CPU holder by a security cable and padlock. Some CPU holders are also provided with a lockable strap to be wrapped around the CPU holder and computer case, to prevent unauthorised removal of the computer case from the CPU holder. Both of these security devices suffer from the problem that a determined thief can simply cut the cable or strap in order to release the computer case.

### SUMMARY OF THE INVENTION

According to a first aspect of the invention there is provided computer case mounting apparatus comprising a top member, a side member extending downwardly from one end thereof, a support member provided at the lower end of the side member and generally opposite the top member, and a side arm extending downwardly from the opposite end of the top member and mounted for reciprocating linear movement, together defining an enclosure adapted to receive part of a computer case, characterised in that:

the side member is height adjustable and comprises height adjustment means;

the support member is provided with an opposed pair of length adjustable retaining arms, adapted to respectively engage the front and back of a computer case, and lockable arm length adjustment means;

the mounting apparatus further comprises locking means provided between the side arm and the top member, operable to lock the side arm at a selected position along the top member; and

the height adjustment means and the lockable arm length adjustment means are located internally to the enclosure, such that they can only be accessed when no computer case is present therein.

The location of the height adjustment means and the lockable arm length adjustment means internally to the enclosure provides the advantage that while the height of the side member and the length of the retaining arms can be adjusted to alter the size of the enclosure to closely receive different sizes and shapes of computer case, they cannot be operated or tampered with when a computer case is present, thereby preventing illegal removal a computer case from the mounting apparatus. The computer case mounting apparatus is thereby fully height, width and length adjustable to accommodate different sizes and shapes of computer case, but only requires a single externally operable locking means, being that between the side arm and the top member, to securely engage a computer case on all sides and thus securely retain a computer case within the mounting apparatus.

The side member preferably comprises an upper part coupled to the top member and a lower part movably mounted on the upper part via the height adjustment means. Preferably, the height adjustment means comprises a spaced series of apertures provided in the lower part and one or more engagement hooks provided on the upper part and adapted for engagement with a corresponding aperture.

The support member preferably further comprises a support platform and a lock enclosure provided below the support platform, the retaining arms having locking sections which extend into the lock enclosure and the lockable arm length adjustment means being provided within the lock enclosure. Preferably, the lockable arm length adjustment means comprises a spaced series of lock apertures correspondingly provided in the locking section of each retaining arm and a lock pin adapted to be located through a collocated pair of lock apertures. Preferably, the lock pin comprises a threaded bolt and is further provided with a correspondingly threaded locking nut.

The locking means preferably comprises a key operated locking arm provided on the side arm and a lock box provided on the underside of the top member, the lock box having a spaced series of lock slots formed therein, adapted for selective locking engagement with the locking arm. The locking arm preferably comprises an axially rotatable lock shaft having a lock lever mounted thereon.

### BRIEF DESCRIPTION OF THE DRAWINGS

An embodiment of the invention will now be described, by way of example only, with reference to the accompanying drawings, in which:

FIG. 1 is a diagrammatic representation of a computer case mounting apparatus according to an embodiment of the invention;

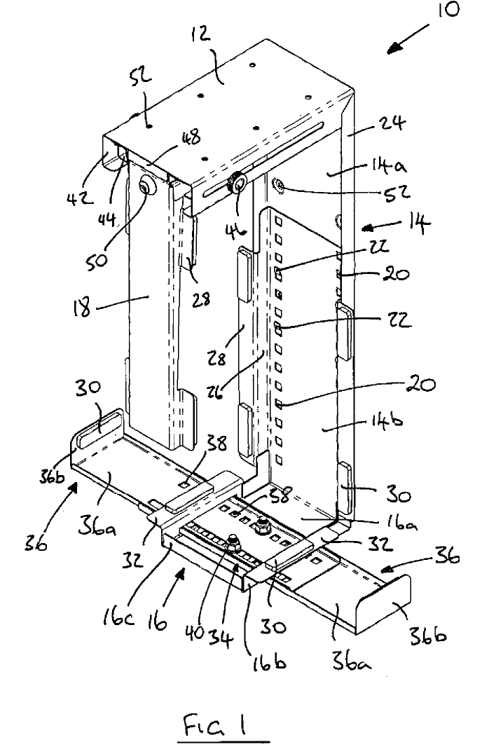

FIG. 2 is a diagrammatic side view of the apparatus of FIG. 1;

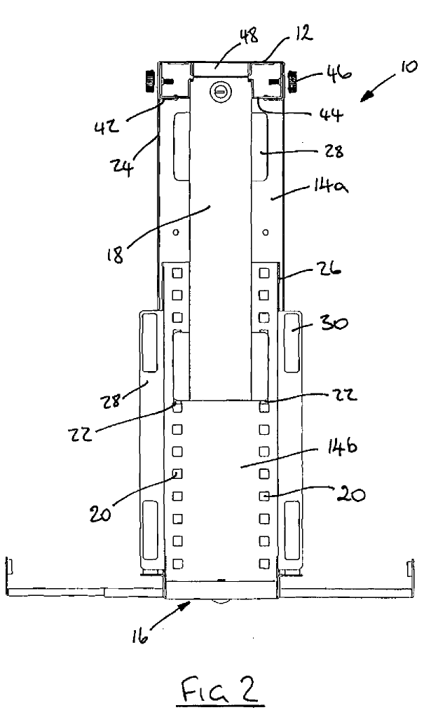

FIG. 3 is a diagrammatic rear view of the apparatus of FIG. 1; and

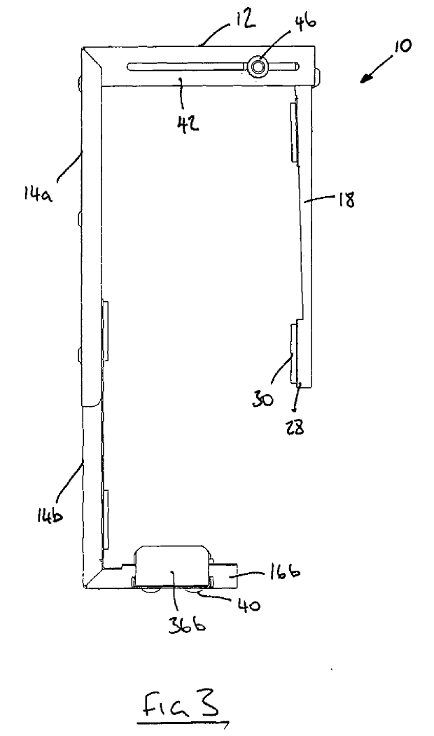

FIG. 4 is a diagrammatic plan view of the apparatus of FIG. 1.

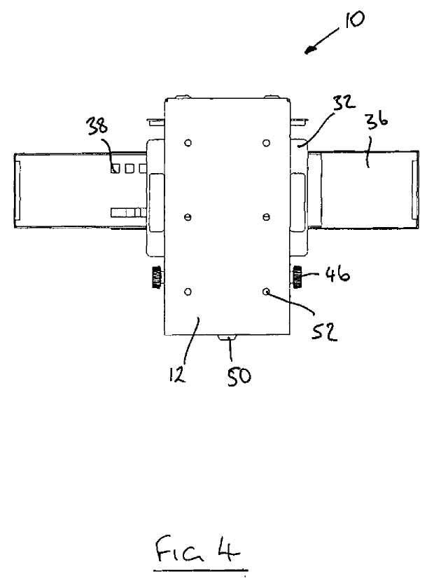

### DESCRIPTION OF THE PREFERRED EMBODIMENTS AND BEST MODE

Referring to the drawings, an embodiment of the invention provides a computer case mounting apparatus 10, which will be referred to as a CPU holder hereinafter, comprising a top member 12, a side member 14, a support member 16 and a side arm 18.

The side member 14 is of adjustable height and comprises a top part 14a and a bottom part 14b, coupled together by way of height adjustment means in the form of two spaced series of apertures 20 provided in the bottom part 14b and four complementarily shaped hooks 22 provided on the top part 14a. The height of the side member 14 can thereby be adjusted in incremental amounts corresponding to the vertical separation of the apertures 20, by moving the lower part 14b up and down relative to the upper part 14a and then engaging the hooks 22 with a selected set of four apertures 20.

The upper part 14a is provided with front and back wall sections 24, and the lower part is similarly provided with front and back wall sections 26, which additionally comprise computer case engagement members 28 which carry contact pads 30. The wall sections 24, 26 define a recess within which the engaging hooks 22 are fully received, so that they are not accessible and will not foul on the surface of a computer case during use. The upper part 14a is integrally formed as an L-shaped bracket with the top member 12.

The support member 16 comprises a base 16a, front and back walls 16b, and a side wall 16c. Support platforms 32, which carry contact pads 30, are provided on the front and back walls 16b. In use, a computer case rests on the contact pads 30 and the support platforms 32. The base 16a, front and back walls 16b, and side wall 16c form a lock enclosure 34. The base 16a is integrally formed as an L-shaped bracket with the lower part 14b of the side member 14.

An opposed pair of length adjustable retaining arms 36 are also provided on the support member 16. Each retaining arm 36 comprises a base 36a and has a short, upstanding wall member 36b at its distal end, on which is provided a contact pad 30. Each retaining arm 36 comprises a locking section in which is provided a spaced series of lock apertures 38, which form one part of the lockable length adjustment means. The locking sections of the retaining arms 36 are respectively located through slots provided in the front and back walls 16b of the support member 16, so that part of each locking section is located within the lock enclosure 34.

Two lock pins 40, in the form of threaded bolts and nuts, are located, upstanding from the base 16a of the support member 16, through a pair of pin apertures (not visible) in the base 16a, and through two pairs of overlapping lock apertures 38. The lock pins 40 are fully retained within the lock enclosure 34, so that they cannot be released when a computer case is present, and do not foul on the computer case. The length of the retaining arms 36 is adjusted by releasing the lock pins 40 and pushing an arm further into the lock enclosure 34 or pulling an arm further out of the lock enclosure 34, to shorten or length the arm respectively. When the desired length is reached the series of lock apertures 38 are arranged to be overlapping and the lock pins 40 are inserted through an overlapping pair of apertures 38 in each series, and fastened. The length of the retaining arms 36 can thereby be varied in incremental amounts equal to the spacing of the lock apertures 38.

The top member 12 is provided with front and back arms 42 which define runner channels in which the side arm 18 is mounted, for reciprocating linear movement. The side arm 18 is provided with a runner 44 on each side, which is located in and rests on the respective runner channel. The side arm 18 can thereby be moved back and forwards along the runner channels, away from and towards the side member 14, to vary the width of the CPU holder 10. The side arm 18 is also provided with computer case engagement members 28 which carry contact pads 30.

The locking means provided between the side arm 18 and the top member 12 comprises a pair of pre-locking screws 46, a lock box 48 and a key operated locking arm 50. The pre-locking screws 46 are provided in slots in the front and back arms 42. The lock box 48 is provided on the underside of the top member 12 and has a spaced series of lock slots (not visible) provided in its downwardly facing surface. The key operated locking arm 50 is provided at the top of the side arm 18, and comprises a key operated, axially rotatable lock shaft on which a lock arm is provided, rotation of the lock shaft bringing the lock arm into engagement with a select one of the lock slots on the lock box 48. The distance between the side member 14 and the side arm 18 can thereby be varied in incremental steps equal to the separation of the lock slots.

Mounting apertures 52 are provided in the top member 12 and the top part 14a of the side member 14 by which the CPU holder 10 may be mounted on the underside of a desk top or on a wall.

In use, the side arm 18 is removed and the height of the side member 14 and the length of the retaining arms 36 are adjusted to match the height and depth of the computer case to be mounted in the CPU holder 10, the computer case is then placed on the support platforms 32 of the support member 16 and against the engagement surfaces 28 of the side member, with the walls 16b of the retaining arms engaging the front and back walls of the computer case. The side arm 18 is then replaced, and is pushed towards the side member 14 until its engagement members 28 come into contact with, or are close to, the respective side wall of the computer case. The pre-locking screws 46 are then locked, to fix the position of the side arm 18. Then the key operated lockable arm 50 is locked, locking the position of the side arm 18 and securing the computer case within the enclosure defined by the CPU holder 10.

The size and dimensions of the enclosure defined by CPU holder 10 can thereby be varied in order to accommodate different sizes and shapes of computer case, but the variation of the height and depth can only be carried out when no computer case is present, since the height adjustment means for the side member 12 and the length adjustment means for the retaining arms 36 are located internally to the enclosure and cannot be accessed or operated when a computer case is present. The CPU holder 10 can thereby be secured around a computer case by a single operating lock, in the form of the key operated locking arm 50 and lock box 48. The CPU holder 10 is thus fully size adjustable, but the size adjustment is secure and tamper-proof during use, and the CPU holder 10 can be easily locked and unlocked by an authorised user by means of the key operated locking arm 50.

Various modifications may be made to the described embodiment without departing from the scope of the invention. For example, the locking means may be replaced by any suitable mechanical locking means, which may be operated by a mechanical key or may be electrically actuated, for example by a key pad. The arm length adjustment means may take a different form to that described, for example the lock apertures may be engaged by a different type of lock pin, which may be fully received within the lock enclosure.

What is claimed is:

1. Computer case mounting apparatus (10) comprising a top member (12), a side member (14) extending downwardly from one end thereof, a support member (16) provided at the lower end of the side member and generally opposite the top member, and a side arm (18) extending downwardly from the opposite end of the top member and mounted for reciprocating linear movement, together defining an enclosure adapted to receive part of a computer case, characterised in that:
the side member is height adjustable and comprises height adjustment means (20, 22);
the support member is provided with an opposed pair of length adjustable retaining arms (36), adapted to respectively engage the front and back of a computer case, and lockable arm length adjustment means (38, 40);
the mounting apparatus further comprises locking means (46, 48, 50) provided between the side arm and the top member, operable to lock the side arm at a selected position along the top member; and
the height adjustment means and the lockable arm length adjustment means are located internally to the enclosure, such that they can only be accessed when no computer case is present therein.

2. Computer case mounting apparatus as claimed in claim 1, wherein the side member comprises an upper part (14a) coupled to the top member and a lower part (14b) movably mounted on the upper part via the height adjustment means.

3. Computer case mounting apparatus as claimed in claim 2, wherein the height adjustment means comprises a spaced series of apertures (20) provided in the lower part and one or more engagement hooks (22) provided on the upper part and adapted for engagement with a corresponding aperture.

4. Computer case mounting apparatus as claimed in claim 1, wherein the support member further comprises a support platform (32) and a lock enclosure (34) provided below the support platform, the retaining arms having locking sections which extend into the lock enclosure and the lockable arm length adjustment means being provided within the lock enclosure.

5. Computer case mounting apparatus as claimed in claim 4, wherein the lockable arm length adjustment means comprises a spaced series of lock apertures (38) correspondingly provided in the locking section of each retaining arm and a lock pin (40) adapted to be located through a collocated pair of lock apertures.

6. Computer case mounting apparatus as claimed in claim 1, wherein the locking means comprises a key operated locking arm (50) provided on the side arm and a lock box (48) provided on the underside of the top member, the lock box having a spaced series of lock slots formed therein, adapted for selective locking engagement with the locking arm.

7. Computer case mounting apparatus as claimed in claim 6, wherein the locking arm comprises an axially rotatable lock shaft having a lock lever mounted thereon.
